(19) United States
(12) Patent Application Publication
(10) Pub. No.: US 2025/0389596 A1
(43) Pub. Date: Dec. 25, 2025

(54) APPARATUS AND METHOD FOR INSPECTING ATTACHMENT STATE OF TEMPERATURE SENSOR OF BATTERY MODULE

(71) Applicant: SK On Co., Ltd., Seoul (KR)

(72) Inventors: Hoe Wook CHOI, Daejeon (KR); Jin Po PARK, Daejeon (KR); Hui Jun SHIN, Daejeon (KR); Chong Pyo HONG, Daejeon (KR); Dae Gyun HWANG, Daejeon (KR)

(21) Appl. No.: 19/209,754

(22) Filed: May 15, 2025

(30) Foreign Application Priority Data
Jun. 24, 2024 (KR) 10-2024-0081568

(51) Int. Cl. G01K 15/00; G01K 1/143; G01K 7/22; H01M 10/48; H01M 10/615; H01M 10/6571

(52) U.S. Cl. CPC G01K 15/007; G01K 1/143; G01K 7/22; H01M 10/486; H01M 10/615; H01M 10/6571

(57) ABSTRACT

A temperature sensor attachment state inspecting apparatus of a battery module, the temperature sensor attachment state inspecting apparatus includes a switch configured to switch electrical connection ON or OFF between a temperature sensor, disposed in a battery module, and a power source, applying power to the temperature sensor, such that the temperature sensor generates heat, and a controller configured to measure a sensing temperature difference before and after the temperature sensor generates heat due to the power source, and to generate attachment state information of the temperature sensor to the battery module, based on the sensing temperature difference.

### CROSS-REFERENCE TO RELATED APPLICATION(S)

This patent document claims the priority and benefits of Korean Patent Application No. 10-2024-0081568 filed on Jun. 24, 2024, the disclosure of which is incorporated herein by reference in its entirety.

### TECHNICAL FIELD

The present disclosure relates to an apparatus and method for inspecting an attachment state of a temperature sensor of a battery module.

### BACKGROUND

Secondary batteries, unlike primary batteries, are convenient, in that secondary batteries can be charged with and discharged of electricity, and thus have drawn significant attention as power sources for various mobile devices and electric vehicles.

An electrode assembly, formed by stacking a cathode plate, an anode plate, and a separator or winding the cathode plate, the anode plate, and the separator in the form of a roll, may be accommodated in a case of a battery cell.

A plurality of battery cells may be stacked in a predetermined direction and accommodated in a battery module or a battery pack. The battery pack may include a plurality of battery modules. Here, a temperature sensor may be provided in the battery module or the battery pack to measure a temperature of the battery cell. The temperature sensor may be mounted in an operation of manufacturing the battery module or the battery pack.

### SUMMARY

When an attachment state of a temperature sensor to a battery module is poor, the temperature sensor may fail to sense a temperature of the battery module, which may significantly reduce the safety of the battery module.

The present disclosure provides an apparatus and method capable of improving the efficiency of inspecting an attachment state of a temperature sensor of a battery module (for example, reducing inspection time, eliminating the need for charging and discharging the battery module, and reducing inspection energy consumption).

According to an aspect of the present disclosure, there is provided a temperature sensor attachment state inspecting apparatus of a battery module, the temperature sensor attachment state inspecting apparatus including a switch configured to switch electrical connection ON or OFF between a temperature sensor, disposed in a battery module, and a power source, applying power to the temperature sensor, such that the temperature sensor generates heat, and a controller configured to measure a sensing temperature difference before and after the temperature sensor generates heat due to the power source, and to generate attachment state information of the temperature sensor to the battery module, based on the sensing temperature difference.

For example, the controller may be configured to generate information indicating that an attachment state of the temperature sensor to the battery module is normal when the sensing temperature difference is less than or equal to a reference temperature difference, and information indicating that an attachment state of the temperature sensor to the battery module is poor when the sensing temperature difference is greater than the reference temperature difference.

For example, the power source may be configured to apply power to the temperature sensor according to a predetermined voltage specification for a predetermined period of time.

For example, the predetermined period of time may be 20 seconds or more and 40 seconds or less. The predetermined voltage specification may be 20 V or more and 100 V or less. The reference temperature difference may be 2° C. or more and 4° C. or less.

For example, the power source may be configured to apply power to the temperature sensor such that the sensing temperature difference is 1° C. or more when an attachment state of the temperature sensor to the battery module is normal.

For example, the switch may be configured to apply power of the power source to the temperature sensor when the switch is in an ON state, and to cut off power of the power source from being applied to the temperature sensor when the switch is in an OFF state.

For example, the temperature sensor may be a plurality of temperature sensors. The switch may be configured to switch electrical connection ON or OFF between each of the plurality of temperature sensors and the power source.

For example, the temperature sensor may include a negative thermistor. The controller may be configured to measure a resistance value of the negative thermistor before power is applied to the negative thermistor by the power source, and to measure the resistance value of the negative thermistor after the negative thermistor generates heat due to the power source.

For example, the temperature sensor attachment state inspecting apparatus may further include a reference resistor electrically connected between the temperature sensor and a ground. The controller may be configured to measure the resistance value, based on a voltage of a node between the temperature sensor and the reference resistor.

For example, the battery module may include a plurality of battery cells. The temperature sensor may be attached to at least one of the plurality of battery cells.

For example, the battery module may further include a busbar electrically connected to the plurality of battery cells, and a support frame configured to support the busbar. The temperature sensor may be disposed between the support frame and at least one of the plurality of battery cells.

For example, the temperature sensor may include a negative thermistor, and a flexible printed circuit board electrically connected to the negative thermistor. The flexible printed circuit board may be disposed between the negative thermistor and the support frame.

For example, the battery module may further include an upper cover covering the plurality of battery cells, a support frame disposed between the upper cover and the plurality of battery cells, and a connector disposed on the support frame. The upper cover may have a connection hole exposing the connector. The power source may be configured to apply power to the temperature sensor through the connector.

According to another aspect of the present disclosure, there is provided a method for inspecting an attachment state of a temperature sensor of a battery module, the method including measuring a sensing temperature of the temperature sensor of the battery module, applying power to the temperature sensor such that the temperature sensor generates heat, measuring the sensing temperature of the temperature sensor to which power is applied, and generating attachment state information of the temperature sensor to the battery module, based on a sensing temperature difference before and after the temperature sensor generates heat.

For example, the generating the attachment state information may include generating information indicating that an attachment state of the temperature sensor to the battery module is normal when the sensing temperature difference is less than or equal to a reference temperature difference, and information indicating that an attachment state of the temperature sensor to the battery module is poor when the sensing temperature difference is greater than the reference temperature difference.

For example, the applying power to the temperature sensor may include periodically checking whether a period of time during which power is applied to the temperature sensor is greater than a predetermined period of time, maintaining application of power to the temperature sensor when the period of time during which power is applied to the temperature sensor is not greater than the predetermined period of time, and stopping application of power to the temperature sensor when the period of time during which power is applied to the temperature sensor is greater than the predetermined period of time.

For example, the temperature sensor may include a plurality of temperature sensors. The applying power to the temperature sensor may include sequentially applying power to the plurality of temperature sensors.

For example, the temperature sensor may include a negative thermistor. The generating the attachment state information may include measuring a resistance value of the negative thermistor before power is applied to the negative thermistor, and measuring the resistance value of the negative thermistor after the negative thermistor generates heat.

For example, the generating the attachment state information may include measuring the resistance value, based on a voltage of a node between a reference resistor, electrically connected between the temperature sensor and a ground, and the temperature sensor.

For example, the applying power to the temperature sensor may include applying power to the temperature sensor such that the sensing temperature difference is 1° C. or more when an attachment state of the temperature sensor to the battery module is normal.

### BRIEF DESCRIPTION OF DRAWINGS

Certain aspects, features, and advantages of the present disclosure are illustrated by the following detailed description with reference to the accompanying drawings.

FIGS. 1A, 1B, and 1C are perspective views of a battery module of an apparatus and method for inspecting an attachment state of a temperature sensor of a battery module according to an example embodiment of the present disclosure;

FIG. 2A is a diagram illustrating a structure in which an attachment state of a temperature sensor to a battery module is normal;

FIG. 2B is a diagram illustrating a structure in which an attachment state of a temperature sensor to a battery module is poor;

FIGS. 3A to 3C are diagrams illustrating a temperature sensor attachment state inspecting apparatus of a battery module according to an example embodiment of the present disclosure;

FIGS. 4A to 4D are diagrams illustrating an inspection process of a temperature sensor attachment state inspecting apparatus of a battery module according to an example embodiment of the present disclosure;

FIG. 5 is a graph illustrating a sensing temperature difference before and after a temperature sensor generates heat according to an example embodiment of the present disclosure; and

FIGS. 6 to 8 are flowcharts illustrating an apparatus and method for inspecting an attachment state of a temperature sensor of a battery module according to an example embodiment of the present disclosure.

### DETAILED DESCRIPTION

Features of the present disclosure disclosed in this patent document are described by example embodiments with reference to the accompanying drawings.

The present disclosure can be implemented in some embodiments to provide an apparatus and method for inspecting an attachment state of a temperature sensor of a battery module.

Before describing embodiments of the present disclosure, the words and terminologies used in the specification and claims should not be construed with common or dictionary meanings, but construed as meanings and conception coinciding the spirit of the present disclosure under a principle that the inventor(s) may appropriately define the conception of the terminologies to explain the present disclosure in the optimum method.

The same reference numerals in the drawings refer to components or elements performing substantially the same function. For ease of description and understanding, the same reference numerals may be used in different embodiments.

As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof.

In addition, the terms “upper side,” “upper portion,” lower side,” “lower portion,” “side surface,” “front surface,” “rear surface” and the like are described based on a direction illustrated the drawings, and may be described differently when a direction of a corresponding object is changed.

In addition, as used herein, terms including an ordinal number such as “first” and “second” may be used to distinguish between components. The ordinal number is used to distinguish the same or similar components from each other, and the meaning of the term should not be limitedly interpreted due to the use of the ordinal number. For example, components combined with the ordinal number should not be construed as limiting the order of use or arrangement by the number. If necessary, respective ordinal numbers may be used interchangeably.

Hereinafter, the present disclosure will be described in detail with reference to the drawings. However, example embodiments are merely illustrative, and the present disclosure is not limited to the example embodiments. For example, hereinafter, a plurality of battery cells 11 of a pouch-type battery module 1 will be described, but a type of the battery module 1 (for example, a cylindrical battery module or a prismatic batteries module) are not limited to the pouch-type battery module, and a specific shape of the pouch-type battery module may also vary depending on a design thereof.

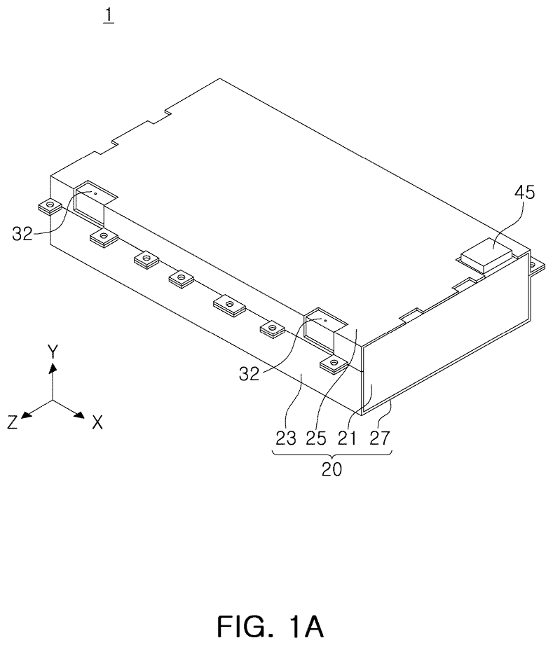

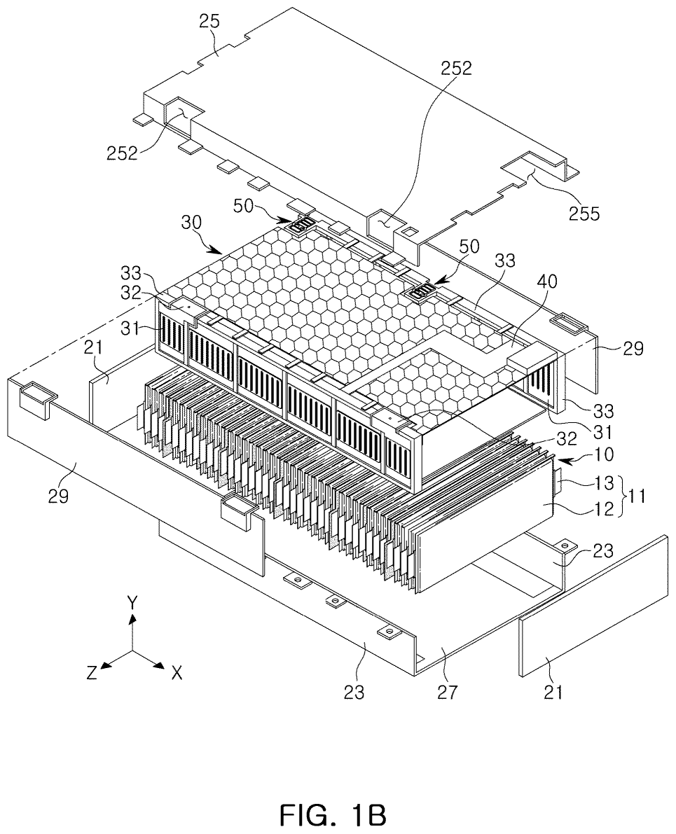

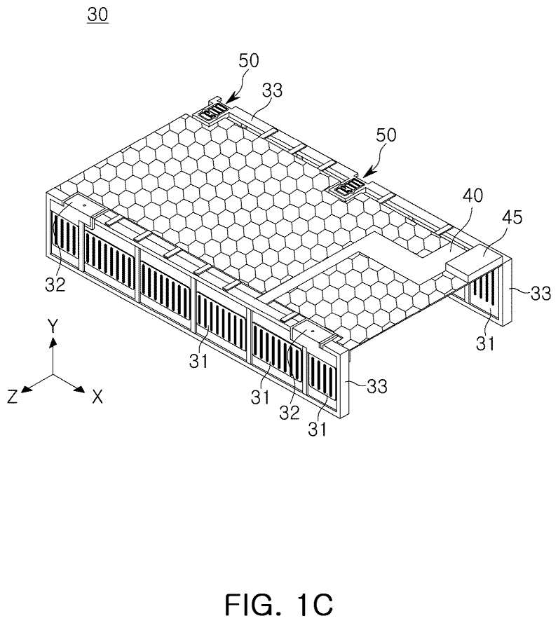

FIG. 1A is a perspective view of a battery module 1 of an apparatus and method for inspecting an attachment state of a temperature sensor of a battery module according to an example embodiment of the present disclosure, FIG. 1B is an exploded perspective view of the battery module, and FIG. 1C is a perspective view of a busbar assembly 30 that may be included in the battery module.

Referring to FIGS. 1A to 1C together, the battery module 1 may include a cell assembly 10 formed by stacking a plurality of battery cells 11, a busbar assembly 30 electrically connecting the plurality of battery cells 11 to each other, and a temperature sensor 50 attached to at least one of the plurality of battery cells 11.

The battery module 1 may include a module case 20 accommodating the cell assembly 10. The module case 20 may include an end frame 21 disposed in a stacking direction of the cell assembly 10, a side frame 23 adjacent to the end frame 21, the side frame 23 disposed to oppose a busbar 31 to be described below, an upper cover 25 covering upper portions of the end frame 21 and the side frame 23, and a lower cover 27 disposed on a lower portion of the cell assembly 10 to support the cell assembly 10.

The upper cover 25 may cover a plurality of battery cells 11. The upper cover 25 may include a terminal hole 252 exposing an electrode terminal 32 of the busbar assembly 30 to be described below, and a connection hole 255 exposing a connector 45 of a circuit portion 40. Depending on a design thereof, the lower cover 27 may be omitted to cool the cell assembly 10.

The cell assembly 10 may be in a state in which the plurality of battery cells 11 are stacked. Wide surfaces of the plurality of battery cells 11 may be stacked on each other, and a state in which the plurality of adjacent battery cells 11 are stacked may be fixed using an adhesive such as a double-sided tape, a hot melt, or the like. It is illustrated that the cell assembly 10 is in a state in which the plurality of battery cells 11 are stacked in an X-axis direction, but the stacking direction is not limited thereto.

The battery cell 11 may include an electrode assembly (not illustrated), a case 12 accommodating an electrolyte, and a lead tab 13 electrically connected to the electrode assembly, the lead tab 13 protruding to at least one side of the case 12.

In the electrode assembly, a cathode plate and an anode plate may be stacked on each other with a separator interposed therebetween in a state in which a wide surface of the cathode plate and a wide surface of anode plate oppose each other. The separator may prevent an electrical short circuit between the cathode plate and the anode plate, and may generate a flow of ions. For example, the separator may include a porous polymer film or a porous nonwoven fabric.

In addition, the electrode assembly may be a jelly-roll type electrode assembly formed by winding the cathode plate, the anode plate, and the separator in a predetermined direction, and various-types of electrode assemblies, such as a stack-type electrode assembly, a Z-folding-type electrode assembly, and a stack-folding-type electrode assembly, may be accommodated in the case 12.

The case 12 may be provided as a pouch-type battery including an accommodation portion accommodating the electrode assembly in an internal space thereof and a sealing portion disposed at an edge of a body portion to seal the internal space. However, the battery cell 11 of the present disclosure is not limited to the shape of the case 12.

The lead tab 13 may protrude to at least one side of the case 12, and may be electrically connected to the busbar 31 of the busbar assembly 30. That is, the lead tab 13 may electrically connect the electrode assembly of the battery cell 11 and the busbar assembly 30 to each other.

The busbar assembly 30, included in the battery module 1, may include a busbar 31 electrically connected to the plurality of battery cells 11, and a support frame 33 supporting the busbar 31. The support frame 33 may be disposed between the upper cover 25 and the plurality of battery cells 11.

The busbar 31 may be disposed on a side portion of the cell assembly 10. The busbar 31 may have a slit into which the lead tab 13 is inserted, and thus may be electrically connected to the lead tab 13. The busbar 31 may have a plurality of slits, and thus may be electrically connected to a plurality of lead tabs 13. That is, the busbar 31 may be electrically connected to one or more battery cells 11. In addition, the busbar 31 may be provided as a plurality of busbars 31 supported by the support frame 33.

The support frame 33 may be disposed on at least one side of the cell assembly 10 in a protrusion direction of the lead tab 13. For example, when the lead tab 13 of each battery cell 11 protrudes to both sides of the cell assembly 10, the busbar 31 and the support frame 33 supporting the same may be disposed on the both sides of the cell assembly 10. In addition, the support frame 33 may include an electrically insulating material to prevent a short circuit between the plurality of busbars 31.

The connector 45 may be disposed on the supporting frame 33. The circuit portion 40 may be mounted on the supporting frame 33, and the circuit portion 40 may electrically connect the temperature sensor 50 and the connector 45 to each other. The circuit portion 40 may connect the temperature sensor 50 to the outside through the connector 45.

In addition, an insulating plate 29 including an electrically insulating material may be provided between the side frame 23 and the busbar 31.

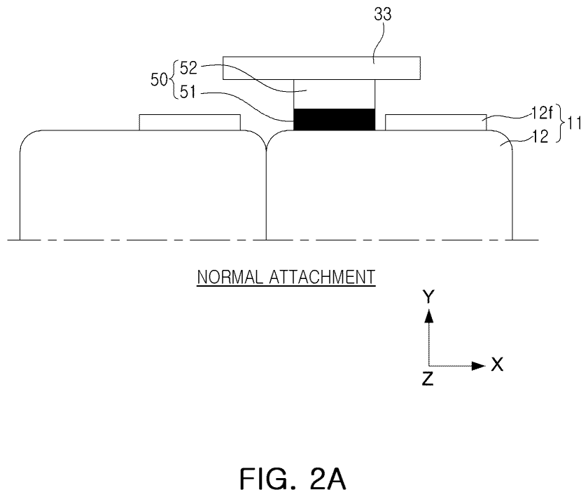

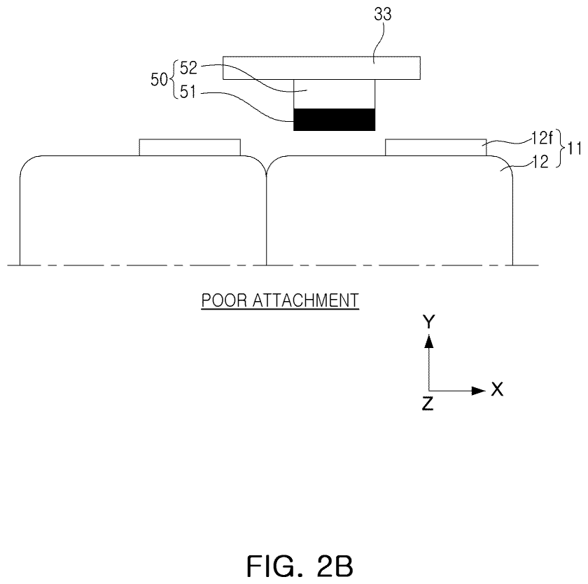

FIG. 2A is a diagram illustrating a structure in which an attachment state of a temperature sensor to a battery module is normal. FIG. 2B is a diagram illustrating a structure in which an attachment state of a temperature sensor to a battery module is poor.

Referring to FIG. 2A, a temperature sensor 50 may be attached to at least one of a plurality of battery cells 11 of a battery module, and an attachment state of the temperature sensor 50 may be normal. Referring to FIG. 2B, the temperature sensor 50 may be spaced apart from the plurality of battery cells 11 of the battery module, and the attachment state of the temperature sensor 50 may be poor. The term “attachment” may encompass contact, bonding, adhesion, close contact, proximity, and adjacency.

The temperature sensor 50 may include a negative thermistor 51 and a flexible printed circuit board 52 electrically connected to the negative thermistor 51. The flexible printed circuit board 52 may be disposed between the negative thermistor 51 and a support frame 33. The negative thermistor 51 may have a resistance value changing according to an ambient temperature, and thus the resistance value may be used to sense a temperature of at least one of the plurality of battery cells 11. The flexible printed circuit board 52 may electrically connect the negative thermistor 51 to a circuit portion (40 in FIG. 1B) and/or a connector (45 in FIG. 1B), and may be flexibly bent.

Referring to FIGS. 2A and 2B, the temperature sensor 50 may be disposed between the support frame 33 and at least one of the plurality of battery cells 11. Accordingly, from an external view, the temperature sensor 50 may be obscured by the support frame 33, making it difficult to visually identify whether the temperature sensor 50 is attached to the battery cell 11. For example, the battery cell 11 may include not only the case 12 but also the folding portion 12f formed by folding an edge of the case 12, and the temperature sensor 50 may be disposed on the folding portion 12f so as not to overlap the folding portion 12f in a Y-direction. The battery cell 11 may have a small region, not overlapping the folding portion 12f in the Y-direction, making it difficult to visually identify whether the temperature sensor 50 is attached to the battery cell 11.

An apparatus and method for inspecting an attachment state of a temperature sensor of a battery module according to an example embodiment of the present disclosure may inspect the attachment state of the temperature sensor 50 without visual inspection of whether the temperature sensor 50 is attached to the battery cell 11.

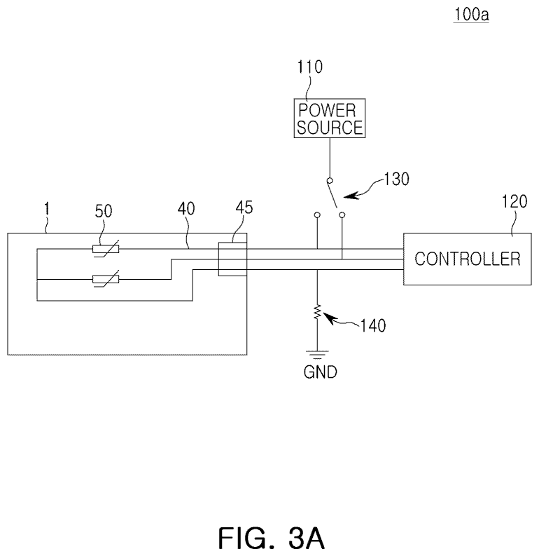

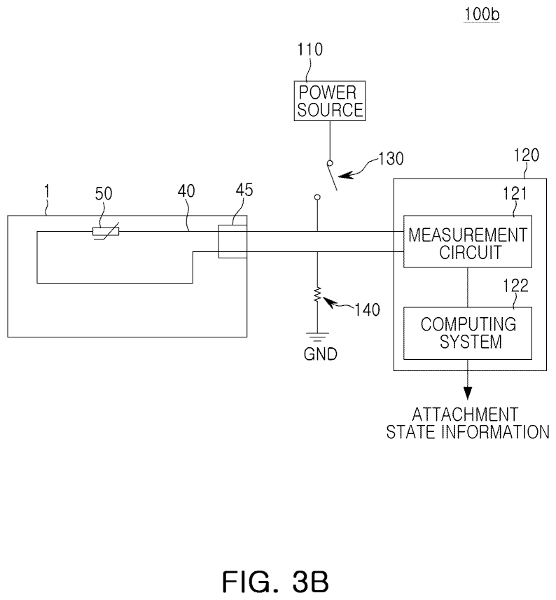

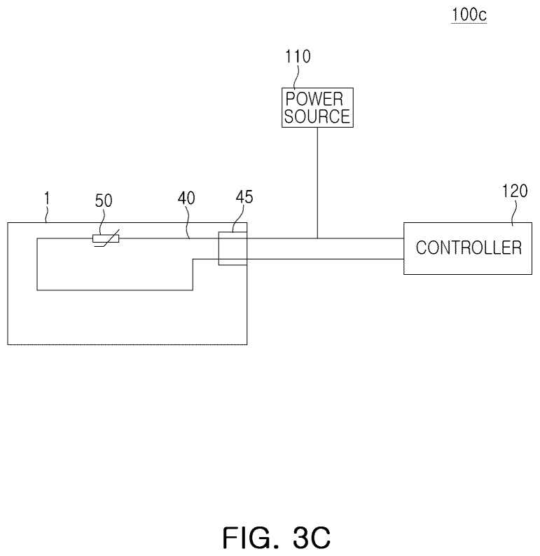

Referring to FIGS. 3A to 3C, temperature sensor attachment state inspection apparatuses 100a, 100b, and 100c of a battery module according to an example embodiment of the present disclosure may include at least one of a power source 110, a controller 120, and a switch 130.

The power source 110 may apply power to a temperature sensor 50 such that the temperature sensor 50, disposed in a battery module 1, generates heat. The switch 130 may switch electrical connection ON or OFF between the power source 110 and the temperature sensor 50. The controller 120 may measure a sensing temperature difference before and after the temperature sensor 50 generates heat due to the power source 110, and may generate attachment state information of the temperature sensor 50 to the battery module 1, based on the sensing temperature difference. When an attachment state of the temperature sensor 50 is normal, heat generated by the temperature sensor 50 may be efficiently dissipated to a plurality of battery cells (11 in FIG. 2A), and thus the temperature sensor 50 may have a small sensing temperature difference. When the attachment state of the temperature sensor 50 is poor, heat generated by the temperature sensor 50 may not be dissipated to a plurality of battery cells (11 in FIG. 2B), and thus the temperature sensor 50 may have a large temperature difference. Accordingly, the sensing temperature difference of the temperature sensor 50 may be used to determine the attachment state of the temperature sensor 50.

Accordingly, the temperature sensor attachment state inspection apparatuses 100a, 100b, and 100c of the battery module according to an example embodiment of the present disclosure may improve the efficiency of inspecting the attachment state of the temperature sensor 50 of the battery module 1 (for example, reducing inspection time, eliminating the need for charging and discharging the battery module, and reducing inspection energy consumption). For example, as compared to a method of inspecting whether the temperature sensor 50 properly senses heat generated by the battery module 1 according to charging and discharging of the battery module 1, a period of time (for example, 30 seconds) required for heat generation of the temperature sensor 50 may be shorter than a period of time (for example, 131 seconds) required for charging and discharging time of the battery module 1. As a result, a period of time required for inspection of the temperature sensor attachment state inspection apparatuses 100a, 100b, and 100c of the battery module may be significantly reduced. For example, charging and discharging of the battery module 1 may cause secondary defects such as a self-discharge ratio (SDR). However, the temperature sensor attachment state inspection apparatuses 100a, 100b, and 100c may inspect the attachment state of the temperature sensor 50 without charging or discharging the battery module 1, thereby preventing secondary defects caused by the charging and discharging of the battery module 1. For example, charging and discharging of the battery module 1 may require charging and discharging equipment and energy consumption. Conversely, the temperature sensor attachment state inspection apparatuses 100a, 100b, and 100c may not require charging and discharging equipment, and may significantly reduce energy consumption.

For example, the power source 110 may apply power to the temperature sensor 50 through the connector 45, and thus the power source 110 may be disposed on the outside of the battery module 1. For example, the connector 45 may be exposed through a connection hole (255 in FIG. 1B) of an upper cover (25 in FIG. 1B), and thus the power source 110 may apply power to the temperature sensor 50 through the connector 45 without additional operations on the fully assembled battery module 1.

For example, the power source 110 may apply power to the temperature sensor 50 according to a predetermined voltage specification (for example, 20 V or more and 100 V or less, such as 60 V) for a predetermined period of time (for example, 20 seconds or more and 40 seconds or less, such as 30 seconds). Accordingly, the sensing temperature difference of the temperature sensor 50 having a normal attachment state may be less than or equal to a reference temperature difference (for example, 2° C. or more and 4° C. and less, such as 3° C.) or less, and the sensing temperature difference of the temperature sensor 50 having a poor attachment state may be greater than the reference temperature difference (for example, 2° C. or more and 4° C. and less).

For example, the power source 110 may be implemented as at least one power supply configured to maintain a constant level of DC voltage. For example, the power source 110 may be implemented to output a substantially constant level of DC voltage by smoothing a DC voltage having a periodically changing level, such as an output of at least one switched mode power source (SMPS), through a capacitor. The number of power supplies, included in the power source 110, may be determined based on the voltage specification of the power source 110.

For example, the fact that the temperature sensor 50 generates heat due to the power source 110 may mean that the sensing temperature difference before and after the temperature sensor 50 generates heat is at least 1° C. or more. That is, the power source 110 may apply power to the temperature sensor 50 such that the sensing temperature difference is at least 1° C. when the attachment state of the temperature sensor 50 to the battery module 1 is normal.

For example, the temperature sensor 50 may include a negative thermistor (51 in FIG. 2A), and the controller 120 may measure a resistance value of the negative thermistor (51 in FIG. 2A) before power is applied to the negative thermistor (51 in FIG. 2A) by the power source 110, and may measure the resistance value of the negative thermistor (51 in FIG. 2A) after the negative thermistor (51 in FIG. 2A) generates heat due to the power source 110. A sensing temperature of the temperature sensor 50 may correspond to the resistance value of the negative thermistor (51 in FIG. 2A), and thus the controller 120 may circuitally measure the sensing temperature of the temperature sensor 50.

Referring to FIG. 3B, the controller 120 may include a measurement circuit 121 and/or a computing system 122. For example, the measurement circuit 121 may be implemented as a digital multimeter, and the computing system 122 may be implemented as a data acquisition system. For example, the measurement circuit 121 may include an analog measurement circuit (for example, a sampling circuit, a buffer circuit, an amplification circuit, or an analog-to-digital conversion circuit), and the computing system 122 may include a processor (for example, a CPU or a GPU), a memory (for example, a volatile memory or a non-volatile memory), a recording an input/output a medium, device, and communication device. For example, the computing system 122 may be at least portion of a monitoring execution system (MES) or may be connected to the MES through the communication device.

Referring to FIGS. 3A and 3B, the temperature sensor attachment state inspecting apparatuses 100a and 100b of the battery module according to an example embodiment of the present disclosure further include a reference resistor 140 electrically connected between the temperature sensor 50 and a ground GND, and the controller 120 may measure the resistance value of the negative thermistor (51 in FIG. 2A), based on a voltage of a node between the temperature sensor 50 and the reference resistor 140. The voltage between the node may be a value obtained by multiplying a voltage of the power source 110 by a voltage drop ratio, and the voltage drop ratio may be a ratio of a resistance value of the reference resistor 140 to a total resistance value of the temperature sensor 50 and the reference resistor 140. The resistance value of the temperature sensor 50 may change according to a temperature change of the temperature sensor 50, the voltage drop ratio may also change, and the voltage of the node may also change. Accordingly, the controller 120 may sense a temperature of the temperature sensor 50 by measuring the voltage of the node.

The reference resistor 140 may have a small resistance value (for example, a resistance value less than the resistance value of the negative thermistor (51 in FIG. 2A) at room temperature) to increase temperature sensing sensitivity and heat generation efficiency of the temperature sensor 50. For example, the reference resistor 140 may be mounted on a measurement printed circuit board, and the measurement printed circuit board may have a plurality of pads electrically connected to the connector 45 and the controller 120 through wires.

Referring to FIGS. 3A and 3B, the switch 130 may apply power of the power source 110 to the temperature sensor 50 when the switch 130 is in an ON state, and may prevent power of the power source 110 from being applied to the temperature sensor 50 when the switch 130 is in an OFF state. A point in time of switching between the ON/OFF states of the switch 130 may be precisely controlled, and thus total power applied to the temperature sensor 50 by the power source 110 may also be precisely controlled. Accordingly, the controller 120 may accurately measure the sensing temperature of the temperature sensor 50.

For example, the controller 120 may control switching between the ON and OFF states of the switch 130. For example, the switch 130 may be implemented as a semiconductor transistor (or a relay), and the controller 120 may apply a control voltage to a gate terminal of the semiconductor transistor. Electrical connection ON or OFF between a source terminal and a drain terminal of the semiconductor transistor may vary according to the control voltage, and thus one of the source terminal and the drain terminal may be electrically connected to the power source 110, and the other one may be electrically connected to a temperature sensor 50. The controller 120 may change whether both ends of the switch 130 are electrically connected to each other by changing a level of the control voltage. For example, the switch 130 may be disposed on the measurement printed circuit board together with the reference resistor 140.

Referring to FIG. 3A, the temperature sensor 50 may be a plurality of temperature sensors 50, and the switch 130 may switch electrical connection ON or OFF between each of the plurality of temperature sensors 50 and the power source 110. Accordingly, inspection for an attachment state of one of the plurality of temperature sensors 50 may reduce the influence of inspection for an attachment state of the other one of the plurality of temperature sensors 50, and thus the controller 120 may accurately measure a sensing temperature of each of the plurality of temperature sensors 50.

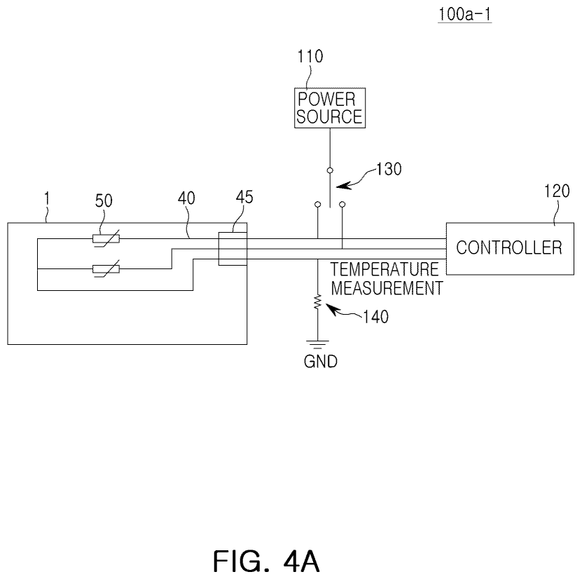

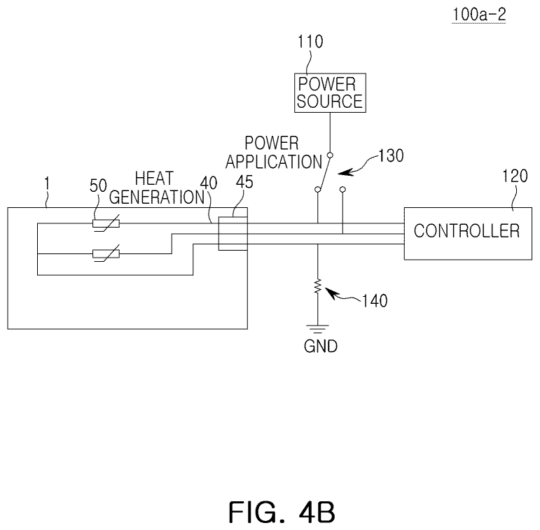

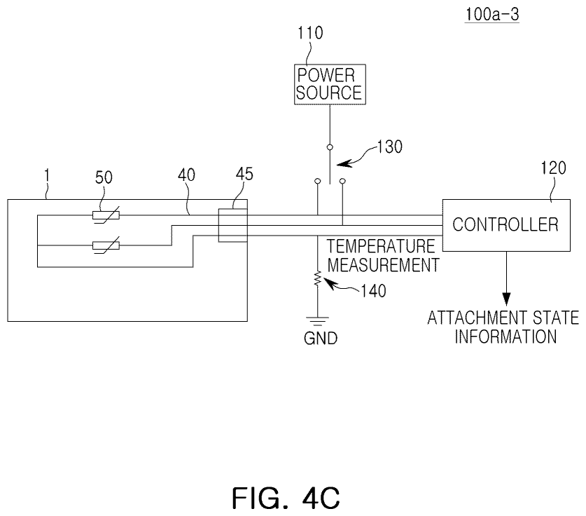

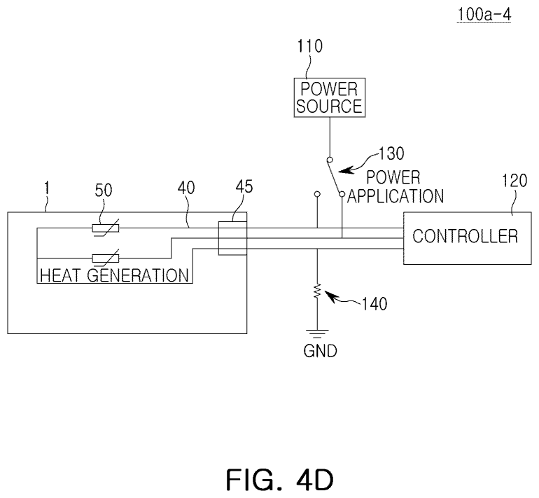

Referring to FIG. 4A, a controller 120 of a temperature sensor attachment state inspection apparatus 100a-1 of a battery module may measure a temperature (for example, a resistance value) of each of a plurality of temperature sensors 50. For example, the controller 120 may sequentially apply an internal voltage to one of the plurality of temperature sensors 50 and the other one and measuring a voltage of a node between the plurality of temperature sensors 50 and a reference resistor 140, thereby measuring the temperature (for example, a resistance value) of each of the plurality of temperature sensors 50.

Referring to FIG. 4B, a switch 130 of a temperature sensor attachment state inspection apparatus 100a-2 of the battery module may electrically connect one of the plurality of temperature sensors 50 and a power source 110 to each other, the power source 110 may apply power to one of the plurality of temperature sensors 50, and one of the plurality of temperature sensors 50 may generate heat.

Referring to FIG. 4C, a switch 130 of a temperature sensor attachment state inspection apparatus 100a-3 of the battery module may cut off an electrical connection between one of the plurality of temperature sensors 50 and the power source 110. The controller 120 may apply an internal voltage to one of the plurality of temperature sensors 50 and measure a voltage of a node between one of the plurality of temperature sensors 50 and the reference resistor 140, thereby measuring a temperature (for example, a resistance value) of one of the plurality of temperature sensors 50. Alternatively, the switch 130 may maintain the electrical connection between one of the plurality of temperature sensors 50 and the power source 110, and the controller 120 may measure the voltage of the node between one of the plurality of temperature sensors 50 and the reference resistor 140, thereby measuring the temperature (for example, a resistance value) of one of the plurality of temperature sensors 50.

Referring to FIG. 4D, a switch 140 of a temperature sensor attachment state inspection apparatus 100a-4 of the battery module may electrically connect the other one of the plurality of temperature sensors 50 and the power source 110 to each other, the power source 110 may apply power to the other one of the plurality of temperature sensors 50, and the other one of the plurality of temperature sensors 50 may generate heat. Thereafter, the switch 130 may cut off an electrical connection between the power source 110 and the other one of the plurality of temperature sensors 50. The controller 120 may apply an internal voltage to the other one of the plurality of temperature sensors 50 and measure a voltage of a node between the other one of the plurality of temperature sensors 50 and the reference resistor 140, thereby measuring a temperature (for example, a resistance value) of the other one of the plurality of temperature sensors 50. Alternatively, the switch 130 may maintain the electrical connection between the other one of the plurality of temperature sensors 50 and the power source 110, and the controller 120 may measure the voltage of the node between the other one of the plurality of temperature sensors 50 and the reference resistor 140, thereby measuring the temperature (for example, a resistance value) of the other one of the plurality of temperature sensors 50.

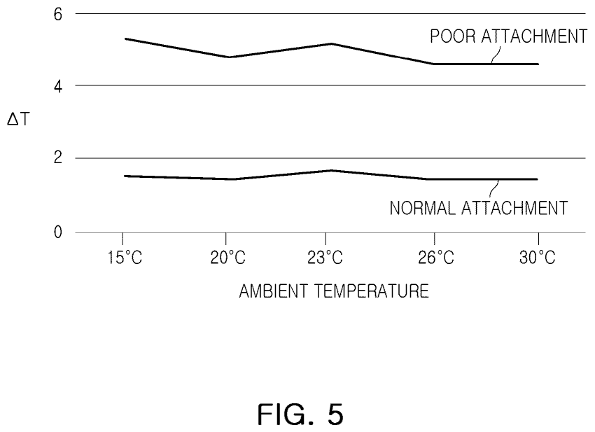

FIG. 5 is a graph illustrating sensing temperature differences of a temperature sensor having a normal attachment state and a temperature sensor having a poor attachment state under a fixed condition in which a power source having a 60V voltage specification applies power for 30 seconds, and different ambient temperature conditions (15° C., 20° C., 23° C., 26° C., and 30° C.), before and after power is applied. The sensing temperature difference of the temperature sensor having a normal attachment state was less than 2° C., whereas the sensing temperature difference of the temperature sensor having a poor attachment state was greater than 4° C.

Referring to FIGS. 3A and 5, when the sensing temperature difference is equal to or less than a reference temperature difference (for example, 2° C. or more and 4° C. or less, such as 3° C.), the controller 120 may generate information indicating that an attachment state of the temperature sensor 150 to the battery module 1 is normal. Conversely, when the sensing temperature difference is greater than the reference temperature difference (for example, 2° C. or more and 4° C. or less, such as 3° C.), the controller 120 may generate information indicating that the attachment state of the temperature sensor 150 to the battery module 1 is poor.

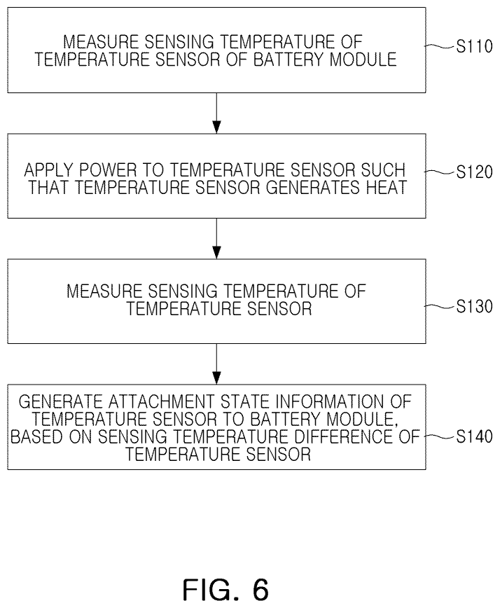

FIGS. 6 to 8 are flowcharts illustrating a method for inspecting an attachment state of a temperature sensor of a battery module according to an example embodiment of the present disclosure. The method may be performed by the temperature sensor attachment state inspection apparatus of the battery module described above, but the present disclosure is not limited thereto.

Referring to FIG. 6, the method of inspecting an attachment state of a temperature sensor of a battery module according to an example embodiment of the present disclosure may include measuring, by a controller, a sensing temperature of the temperature sensor of the battery module (S110), applying, by a power source, power to the temperature sensor such that the temperature sensor generates heat (S120), measuring, by the controller, the sensing temperature of the temperature sensor to which power is applied (S130), and generating, by the controller, attachment state information of the temperature sensor to the battery module, based on a sensing temperature difference before and after the temperature sensor generates heat (S140). Accordingly, the method according to an example embodiment of the present disclosure may improve the efficiency of inspecting the attachment state of the temperature sensor of the battery module (for example, reducing inspection time, eliminating the need for charging and discharging the battery module, and reducing inspection energy consumption).

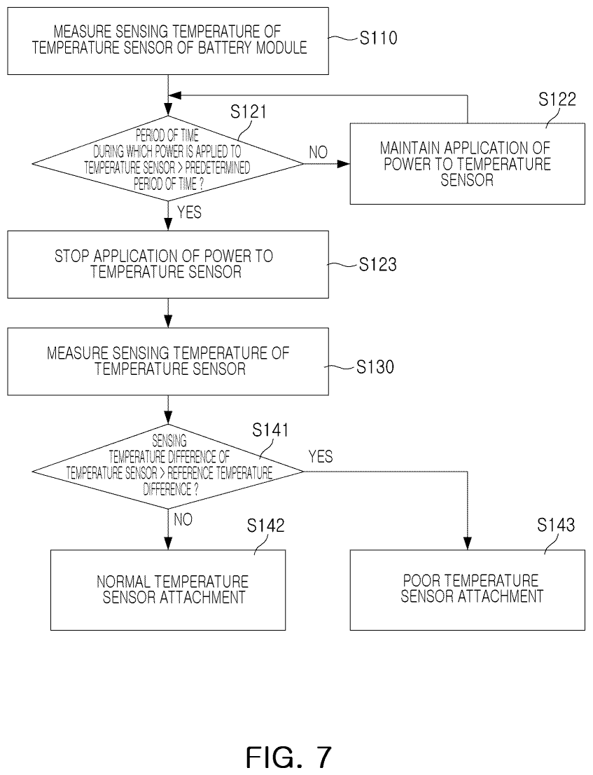

Referring to FIG. 7, an operation of generating the attachment state information (S140 in FIG. 6) may include comparing, by the controller, the sensing temperature difference with a reference temperature difference (S141), generating information indicating that an attachment state of the temperature sensor to the battery module is normal when the sensing temperature difference is less than or equal to the reference temperature difference (S142), and generating information that the attachment state of the temperature sensor to the battery module is poor when the sensing temperature difference is greater than the reference temperature difference (S143).

Referring to FIG. 7, an operation of applying power to the temperature sensor (S120 in FIG. 6) may include periodically checking, by the controller, whether a period of time during which power is applied to the temperature sensor is greater than a predetermined period of time (S121), maintaining application of power to the temperature sensor when the period of time during which power is applied to the temperature sensor is not greater than the predetermined period of time (S122), and stopping application of power to the temperature sensor when the period of time during which power is applied to the temperature sensor is greater than the predetermined period of time (S123).

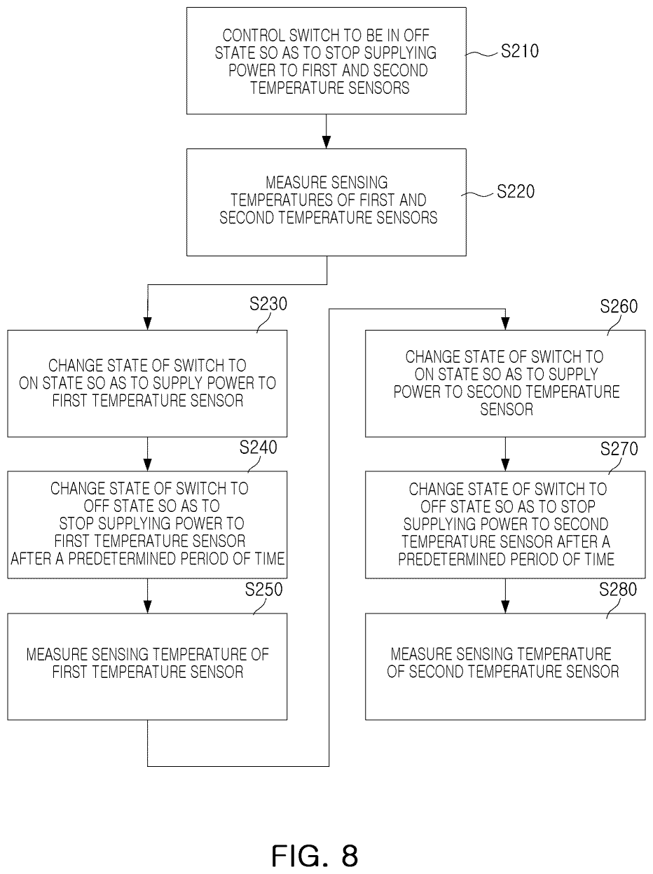

Referring to FIG. 8, the temperature sensor may include a plurality of temperature sensors (first and second temperature sensors), and the operation of applying power to the temperature sensor (S120 in FIG. 6) may include sequentially applying power to the plurality of temperature sensors (S230, S240, S260, and S270).

For example, referring to FIGS. 3A and 8, the method according to an example embodiment of the present disclosure may include controlling, by a controller 120, a switch 130 to be in an OFF state so as to stop supplying power to a plurality of temperature sensors (first and second temperature sensors) (S210), measuring sensing temperatures of the plurality of temperature sensors (first and second temperature sensors) (S220), changing a state of the switch 130 to an ON state so as to supply power to one (first temperature sensor) of the plurality of temperature sensors (S230), changing the state of the switch 130 to the OFF state so as to stop supplying power to one (first temperature sensor) of the plurality of temperature sensors after a predetermined period of time (S240), measuring a sensing temperature of one (first temperature sensor) of the plurality of temperature sensors (S250), changing the state of the switch 130 to the ON state so as to supply power to the other one (second temperature sensor) of the plurality of temperature sensors (S260), changing the state of the switch 130 to the OFF state so as to stop supplying power to the other one (second temperature sensor) of the plurality of temperature sensors after a predetermined period of time (S270), and measuring a sensing temperature of the other one (second temperature sensor) of the plurality of temperature sensors (S280).

An apparatus and method for inspecting an attachment state of a temperature sensor of a battery module according to an example embodiment of the present disclosure may improve the efficiency of inspecting the attachment state of the temperature sensor of the battery module (for example, reducing inspection time, eliminating the need for charging and discharging the battery module, and reducing inspection energy consumption).

Only specific examples of implementations of certain example embodiments are described. Variations, improvements and enhancements of the disclosed example embodiments and other example embodiments may be made based on the disclosure of this patent document.

What is claimed is:

1. A temperature sensor attachment state inspecting apparatus of a battery module, the apparatus comprising:
a switch configured to switch electrical connection ON or OFF between a temperature sensor, disposed in a battery module, and a power source, applying power to the temperature sensor, such that the temperature sensor generates heat; and
a controller configured to measure a sensing temperature difference before and after the temperature sensor generates heat due to the power source, and to generate attachment state information of the temperature sensor to the battery module, based on the sensing temperature difference.

2. The apparatus of claim 1, wherein the controller is configured to generate:
information indicating that an attachment state of the temperature sensor to the battery module is normal when the sensing temperature difference is less than or equal to a reference temperature difference, and
information indicating that an attachment state of the temperature sensor to the battery module is poor when the sensing temperature difference is greater than the reference temperature difference.

3. The apparatus of claim 2, wherein the power source is configured to apply power to the temperature sensor according to a predetermined voltage specification for a predetermined period of time.

4. The apparatus of claim 3, wherein
the predetermined period of time is 20 seconds or more and 40 seconds or less,
the predetermined voltage specification is 20 V or more and 100 V or less, and
the reference temperature difference is 2° C. or more and 4° C. or less.

5. The apparatus of claim 1, wherein the power source is configured to apply power to the temperature sensor such that the sensing temperature difference is 1° C. or more when an attachment state of the temperature sensor to the battery module is normal.

6. The apparatus of claim 1, wherein the switch is configured to apply power of the power source to the temperature sensor when the switch is in an ON state, and to cut off power of the power source from being applied to the temperature sensor when the switch is in an OFF state.

7. The apparatus of claim 6, wherein
the temperature sensor is a plurality of temperature sensors, and
the switch is configured to switch electrical connection ON or OFF between each of the plurality of temperature sensors and the power source.

8. The apparatus of claim 1, wherein
the temperature sensor includes a negative thermistor, and
the controller is configured to measure a resistance value of the negative thermistor before power is applied to the negative thermistor by the power source, and to measure the resistance value of the negative thermistor after the negative thermistor generates heat due to the power source.

9. The apparatus of claim 8, further comprising:
a reference resistor electrically connected between the temperature sensor and a ground,
wherein the controller is configured to measure the resistance value, based on a voltage of a node between the temperature sensor and the reference resistor.

10. The apparatus of claim 1, wherein
the battery module includes a plurality of battery cells, and
the temperature sensor is attached to at least one of the plurality of battery cells.

11. The apparatus of claim 10, wherein
the battery module further includes a busbar electrically connected to the plurality of battery cells, and a support frame configured to support the busbar, and
the temperature sensor is disposed between at least one of the plurality of battery cells and the support frame.

12. The apparatus of claim 11, wherein
the temperature sensor includes a negative thermistor, and a flexible printed circuit board electrically connected to the negative thermistor, and
the flexible printed circuit board is disposed between the negative thermistor and the support frame.

13. The apparatus of claim 10, wherein
the battery module further includes an upper cover covering the plurality of battery cells, a support frame disposed between the upper cover and the plurality of battery cells, and a connector disposed on the support frame,
the upper cover has a connection hole exposing the connector, and
the power source is configured to apply power to the temperature sensor through the connector.

14. A method for inspecting an attachment state of a temperature sensor of a battery module, the method comprising:
measuring a sensing temperature of the temperature sensor of the battery module;
applying power to the temperature sensor such that the temperature sensor generates heat;
measuring the sensing temperature of the temperature sensor to which power is applied; and
generating attachment state information of the temperature sensor to the battery module, based on a sensing temperature difference before and after the temperature sensor generates heat.

15. The method of claim 14, wherein the generating the attachment state information includes generating:
information indicating that an attachment state of the temperature sensor to the battery module is normal when the sensing temperature difference is less than or equal to a reference temperature difference, and
information indicating that an attachment state of the temperature sensor to the battery module is poor when the sensing temperature difference is greater than the reference temperature difference.

16. The method of claim 15, wherein the applying power to the temperature sensor includes:
periodically checking whether a period of time during which power is applied to the temperature sensor is greater than a predetermined period of time,
maintaining application of power to the temperature sensor when the period of time during which power is applied to the temperature sensor is not greater than the predetermined period of time, and
stopping application of power to the temperature sensor when the period of time during which power is applied to the temperature sensor is greater than the predetermined period of time.

17. The method of claim 14, wherein
the temperature sensor includes a plurality of temperature sensors, and
the applying power to the temperature sensor includes sequentially applying power to the plurality of temperature sensors.

18. The method of claim 14, wherein
the temperature sensor includes a negative thermistor, and
the generating the attachment state information includes measuring a resistance value of the negative thermistor before power is applied to the negative thermistor, and measuring the resistance value of the negative thermistor after the negative thermistor generates heat.

19. The method of claim 18, wherein the generating the attachment state information includes measuring the resistance value, based on a voltage of a node between a reference resistor, electrically connected between the temperature sensor and a ground, and the temperature sensor.

20. The method of claim 14, wherein the applying power to the temperature sensor includes applying power to the temperature sensor such that the sensing temperature difference is 1° C. or more when an attachment state of the temperature sensor to the battery module is normal.
